(19) United States
(12) Patent Application Publication
(10) Pub. No.: US 2013/0041740 A1
(43) Pub. Date: Feb. 14, 2013

(54) COUPONING SYSTEMS AND METHODS

(71) Applicants: Shelley B. Tyler, Aurora, CO (US); Paul Sybrowsky, Provo, UT (US); Lynne Sybrowsky, Provo, UT (US)

(72) Inventors: Shelley B. Tyler, Aurora, CO (US); Paul Sybrowsky, Provo, UT (US); Lynne Sybrowsky, Provo, UT (US)

(21) Appl. No.: 13/544,282

(22) Filed: Jul. 9, 2012

Related U.S. Application Data
(60) Provisional application No. 61/505,378, filed on Jul. 7, 2011.

(51) Int. Cl. G06Q 30/02

(52) U.S. Cl. 705/14.35

(57) ABSTRACT

The invention contemplates a website where various merchants may have their own sub-page(s) where they offer discounts and promotional materials on goods or services offered in their stores, which are typically brick and mortar retail locations. With the sub-pages, the merchants can design their own coupons or promotions and provide coupons or other documents that may be printed by the consumer. These coupons or other discounts will have traceable indicia, such as barcodes, so that when they are redeemed at the merchant location, the merchant can track information on their redemption. To be able to offer such coupons and discounts, the merchant simply needs to be a member of the site.

### CROSS-REFERENCES TO RELATED APPLICATIONS

This application claims the benefit of U.S. Provisional Application No. 61/505,378, filed Jul. 7, 2011, entitled “Couponing Systems and Methods.” The entire disclosure of which is incorporated herein by reference for all purposes.

### BACKGROUND OF THE INVENTION

This invention relates generally to the field of electronic commerce, and in particular to promotional sites that offer coupons and other promotional information.

Coupons have long been widely used to promote items sold by merchants. The coupons are advantageous to the consumer because the consumer is able to receive a discount or money back from a given purchase. At the same time, coupons are a convenient way for the merchant to advertise specific goods or services and for manufacturers to increase sales. This invention relates to various techniques for providing such promotions and coupons on e-commerce sites, such as websites.

### BRIEF SUMMARY OF THE INVENTION

Embodiments of the invention provide methods, devices, and systems for advertising coupons, discounts, or other promotional materials online. According to one aspect, a method for advertising coupons online is provided. The method may include displaying a website having a plurality of sub-pages where each sub-page is associated with a respective merchant to allow the merchant to offer discounts and promotional materials on goods or services offered in their respective store or stores. The method may also include displaying a coupon on a sub-page of one of the merchants. The coupon may be associated with a discount or promotional material being offered by the merchant. The coupons may also have traceable indicia so that when the coupon is redeemed at the merchant's store, the merchant is able to track information on the coupon's redemption. The method may further include receiving a selection from a customer to download the coupon and transmitting data to the customer to allow the coupon to be printed by the customer for redemption at the merchant's store.

According to one embodiment, the coupon may be one of a first amount of coupons associated with the discount or promotional material being offered by the merchant. The first amount of coupons may be available for download on the merchant's sub-page by customers for or within a defined amount of time (e.g., 100 coupons may be offered for download for 1 month). In such embodiments, the method may additionally include receiving a plurality of selections from various customers within the defined amount of time for download of the coupon. The selections received may be sufficiently great such that the first amount of coupons is exhausted (e.g., 100 selections may be received within the 1 month time frame for the 100 coupons available for download). The method may additionally include receiving instructions from the merchant to make a second amount of coupons available for download on the sub-page within the defined amount of time and displaying a coupon of the second amount of coupons on the sub-page for download by customers (e.g., the merchant may instruct that an additional 100 coupons be available for download on the merchant's sub-page). In one embodiment, the second amount of coupons is associated with a different discount or promotional material than the first amount of coupons so that discounts are offered for different goods or services.

The merchant may pay a single fee that covers both the first amount of coupons and the second amount of coupons for the defined amount of time. The method may also involve various buffer mechanisms that allow download of the coupons to be delayed or denied. For example, in one embodiment, the plurality of selections received from customers may be greater than the first amount of coupons. In such an embodiment, the method may further include notifying the merchant that the plurality of selections is greater than the first amount of coupons and receiving authorization from the merchant to allow download of coupons beyond the first amount of coupons.

In another embodiment, the discounts or promotional materials offered by the various merchants may be categorized. In such embodiments, the website may be configured to limit the discounts or promotional materials offered for each category within one or more defined geographical boundaries. In a specific embodiment, the website limits the discounts or promotional materials offered for each category to a single merchant within each defined geographical boundary.

The customer may also or alternatively pay a fee or perform an act that allows the customer to download the coupon. For example, in one embodiment, the method additionally includes displaying a form to the customer in response to receiving the selection from the customer to download the coupon, receiving input from the customer for one or more data fields of the form that are configured for customer input, and allowing the data to be transmitted to the customer in response to receiving input from the customer. In a specific embodiment, receiving a selection from the customer to download the coupon may include receiving a selection of a link transmitted to the customer to advertise the coupon. Alternatively, the method may include receiving payment from the customer for download of the coupon. The website may limit the customer's download of coupons based on a payment received from the customer. The website may also limit display of coupons to those coupons having a defined discount, such as a defined percentage or amount off the regular retail price of the promoted good or service.

According to another aspect, a computer system for advertising coupons, discounts, or promotional materials online is provided. The computer system may include a processor and a computer readable medium having instructions stored thereon. The instructions may cause the processor to perform the methods described previously and described elsewhere herein so as to advertise the coupons.

According to another aspect, the invention provides a method for allowing a wide range of merchants to advertise or promote their goods electronically, such as by use of a computer system that generates websites over the Internet. As such, the invention may utilize one or more computer servers as is known in the art in order to render appropriate display screen screens on user computers that are connected to the Internet and are logged into the appropriate site. As one specific example, the invention contemplates a website where various merchants may have their own sub-page(s) where they offer discounts and promotional materials on goods or services offered in their stores, which are typically brick and mortar retail locations. With the sub-pages, the merchants can design their own coupons or promotions and provide coupons or other documents that may be printed by the consumer. These coupons or other discounts will have traceable indicia, such as barcodes, so that when they are redeemed at the merchant location, the merchant can track information on their redemption. To be able to offer such coupons and discounts, the merchant simply needs to be a member of the site.

In another embodiment, the invention provides a method for providing discounts or other coupons online to specific merchants who have entered into a contract with the online site. The advantage of such a contract is that the merchant is able to design their own coupons and promotions but is not required to give a certain percentage of the value of the promotions or coupons to the website owner. Rather, a fixed or flat fee can be provided so that regardless of the number of coupons that are sold and/or redeemed, the merchant will only have to pay the pre-negotiated fee. As one specific example, a merchant may have a certain time period, such as a month, in which to offer a certain number of coupons. For example, the merchant may have the ability to sell five hundred 50% off coupons during a thirty day window. Once the coupons are sold, the merchant has no additional obligation to sell any more coupons. However, if it is desired, the merchant may add an additional promotion that would extend for the full thirty days of the contract. Hence, one specific advantage is the ability to continually add additional promotions or coupons for the full contract. Such promotions may be the same or different from the promotions initially offered at the beginning of the time period. However, the merchant is not obligated to pay a percentage of the coupons to the website owner as all fees have previously been paid.

In a further aspect, the merchants that offer goods on the website may be categorized and the rules configured such that only one specific class of merchant and/or good may be offered from the website. For example, if the merchant is a pizza store, that merchant would be the only merchant offering pizzas for sale in a given geographical region. In a further aspect, various techniques may be employed to notify potential consumers of the coupons or promotions. For example, the website may send out emails, text messages, or the like to all of its members to apprise them of the specific promotions or discounts. Further, these text emails or other communications may be customer tailored to the user, such as by geography, preference for a specific type of good, or the like.

### BRIEF DESCRIPTION OF THE DRAWINGS

The present invention is described in conjunction with the appended figures:

FIG. 1 illustrates a method for advertising coupons via a website according to an embodiment of the invention.

FIG. 2 illustrates another method for advertising coupons via a website according to an embodiment of the invention.

FIGS. 3A-J illustrate various screen shots of a website that allows a merchant to perform various advertisement operations according to an embodiment of the invention.

FIGS. 4A-H illustrate various screen shots of a website that allows an administrator to perform various operations according to an embodiment of the invention.

FIGS. 5A-D illustrate various screen shots of a website that allows a customer to perform various operations according to an embodiment of the intention.

FIG. 6 illustrates a system for advertising coupons, discounts, or other promotional materials according to an embodiment of the invention.

FIG. 7 illustrates an exemplary computer system that may be used to perform the methods described herein according to an embodiment of the invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE SPECIFIC EMBODIMENTS

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks

Embodiments of the invention provide systems and methods for advertising coupons or other discounts online. The discounts or coupons may have various forms including a percentage or amount of a particular good or service, an advertising of a price for a good or service offered, an advertisement for an hourly rate for the performance of a service, and the like. Examples of such discounts include 50% the regular retail price of a good, a hotel room offered in a resort location at a specified price, a dollar per hour rate for construction related services, and the like. For convenience, the disclosure herein will mainly describe these discounts as “coupons,” although it should be realized that such a description is not limited to any one particular type of discount and may include any promotional offer for goods and/or services.

According to one embodiment a website may be used to advertise the coupons. The website may be affiliated with a coupon enrollment or advertising program (referred to hereinafter as the coupon program). The coupon program may allow merchants to offer discounts or other promotional materials, such as coupons for reduced prices on offered goods or services. The coupon program may allow customers and merchants to enroll in a coupon or discount service that provides the dual benefit of reduced cost to the customers and increased revenue to the merchants. The coupons may be displayed to the customers on sub-pages of a coupon program website. Each of the sub-pages may be associated with a respective merchant that offers a good or service. For example, a pizza business may have a webpage or sub-page that offers coupons on pizzas while an electrician has a webpage that offers coupons on electrical work. The coupons may be downloaded and printed by the customer for redemption at a store of the merchant. The coupons may have traceable indicia that allow the merchant to track when, where, and how often the coupons are redeemed. According to one embodiment, the coupons may have machine readable indicia, such as a bar code that allows such tracking According to another embodiment, the coupons may have a logo or other markings that allows the merchant to identify the coupon as being obtained from the website.

The website may have a “neighborhood feel” in that a customer is provided with coupons, discounts, and/or promotional materials from merchants in close proximity to the customer. To receive such offers, the customer may input their zip code, home street address, or current location, or alternatively, the location of the customer may be determined using geographic location techniques, such as locating the customer's mobile device. Various coupons, discounts, or promotional offers may be displayed to the customer based on the customer's location. In this manner, the discounts of merchants close to the customer, or within the customer's “neighborhood,” which the customer is more likely to frequent and/or be interested in may be displayed to the customer. This neighborhood feel aspect of the website may promote the establishment and development of businesses in close proximity to enrolled customers. In one embodiment, the website will be designed so that the merchant's target customers are within a defined radius of the merchant, such as within 5 miles. This designed marketing enhances the “neighborhood-like” aspect for the merchant and may encourage repeat business to the merchant's webpage.

In one embodiment, the coupon advertisements may be limited based on a category of the good or service offered. For example, the discounts or promotional materials offered by each merchant may be categorized and the displayed coupons may be limited to a defined number based on the assigned or selected category. This categorical limitation may be in addition to or in place of the geographic limitation described above. These categorical limitations may offer advertising advantages to certain merchants, such as those willing to pay for coupon program services, those willing to discount their goods or services a defined amount or more, or those having a loyal or longstanding business relationship with an entity offering the coupon program services. For example, coupon advertisements within the category of “automobile repair” may be limited to two merchants or two advertisements within a defined geographical area. When a customer within the defined geographical area selects the category “automobile repair”, the coupons of the two merchants may be displayed.

The merchants within each geographical area allowed to advertise coupons may be rotated on a period basis or based on whether new, exciting, and/or unique offers are submitted. In another embodiment, successful merchants may be allowed to remain as one of a limited number of advertiser, or as a sole advertiser, as long as their discounts, coupons, or promotional offers remain attractive, which may be measured by the amount the coupons are downloaded and redeemed. In one embodiment, the coupons, discounts, or promotional materials offered for each category may be limited to a single merchant or advertisement within each defined geographical boundary.

Various techniques may be employed to notify potential consumers of the coupons or promotions. For example, the website may send out emails, text messages, or the like to all of its enrolled customers to notify them of specific promotions or discounts. Further, these text emails or other communications may be customer tailored to the customer, such as by geography, preference for a specific type of good, or the like. According to another embodiment, the coupons or promotions may be sent to a company for distribution to its employees. For example, the promotion may be emailed to a human resource director, or other employee of a company, for subsequent distribution to all or a portion of the company's employees. Alternatively, the company may provide the email address of each employee so that the coupons or promotions may be sent directly to each employee. The coupons or promotions sent to the company or employees may be related to the company business or something that the employees are interested in.

In a specific embodiment, the promotions are sent to the enrolled customers via email or text message. The email or text message may include a link that links the customer to the merchant's webpage offering the coupon or promotion, or may link the customer to another page where the coupon or promotion may be downloaded. The customer may be required to pay a fee for each coupon they download or to perform an action, such as completing a survey or questionnaire. In one embodiment, the customer pays a predetermined amount for a defined number of coupon downloads. A portion of the fee may be transmitted to the merchant each time one of the merchant's coupons is downloaded, thus providing an incentive to the merchant to offer enticing coupons. According to another embodiment, the merchant may pay a fee to advertise a defined number of coupons and/or advertise coupons for a defined amount of time.

These aspects and other aspects of the invention will be more evident with reference to the two non-limiting examples of promotional websites described below.

### Embodiment 1

According to a first embodiment, enrolled merchants can advertise a defined number of coupons for a defined price, advertise an unlimited number of coupons for a defined period, or some combination thereof. Essentially, the merchants may be offered unlimited advertisements for a defined length of time for a flat fee. For example, merchants may be allowed unlimited advertisements for a 1 month period for a fixed price. The flat fee may allow the merchant to advertise a single product for the defined period or advertise multiple products, either consecutively or simultaneously, for the defined period. According to some embodiments, the flat fee may allow the merchant to advertise an initial amount of coupons within a defined period, which amount may be adjusted depending on the demand for the coupons. For example, if 500 coupons are initially offered for a 1 month period of time, an additional 500 coupons may be offered if demand for the coupons is great enough to exhaust the 500 coupon supply within the 1 month time period.

Other aspects of the website may include emailing out information about monthly deals of the merchants to the enrolled customers, which will attract voluminous amounts of people to the merchant's webpage. The emails may be tailored to the customer based on geographic location, interests, prior coupon downloads, and the like.

Merchants may add and/or change coupons on a daily, weekly or monthly basis. The webpage may promote the merchant's coupons in addition to other products or services offered by the merchant. The website may include various on-line illustrations and/or web design galleries to assist the merchants in creating the advertisement. As described previously, customers can print off the merchant's coupons from the webpage, which coupon may have a traceable bar code or other indicia that allow the merchant to identify the coupon as being obtained from the website and/or allows other tracking and redemption information to be obtained. The coupon may also show the date of purchase, notice of expiration, possible terms, limitations, and/or restrictions associated with the coupon or promotion.

Merchants may edit their promotions and coupons, via the website process, which will enable the merchant to control the transaction from the beginning of the process through completion of the transaction. The webpage may also provide merchants with meaningful data, such as the volume of customer views on the webpage, the number of clicks on the coupon, and/or the number of coupon downloads.

Merchants can promote their products and services at any determined price and keep all or a majority of their profits generated from the webpage since the merchant is paying a flat fee for advertising the coupons. As such, the merchant remains in control of their profits, unlike current coupon advertising websites where 40% or more of the sale of a purchased coupon is kept by the entity offering the website services. Further, the merchant is not required to discount a good or service by a defined amount meaning that the merchant has complete control over the discount offer and, thus, the likelihood that a customer will download and redeem the coupon. This is in contrast to current coupon advertising websites that frequently require a merchant to offer discounts of at least 50% of more off regular retail prices in order to advertise on their website.

According to some embodiments, the website may categorize each good or services offered by the merchants and may alphabetize each of the merchants. Exemplary categories include auto repair, hair salons, restaurants, spas, and the like. As described above, the website may allow only one merchant in a specific industry, in a specific geographic location per month to promote their product or service. This may offer an advertising advantage to those specific merchants, thus, providing an incentive for the merchants to continue advertising their goods and services and coupons via the website. The exclusive or semi-exclusive advertisement may also incentives customer to continually visit the merchant's webpage if the coupon and offered good or services is sufficiently attractive. Further, attractive coupons will promote word of mouth advertising for the website and/or merchant.

The website may further attract and retain customers for significant periods of time by offering numerous merchants and promotional deals for the customer to view. Other conventional advertising websites typically limit promotional deals from one to seven deals per day or per week. Customer may quickly be discouraged from viewing these websites if they do not find what they are looking for. In contrast, the website described herein provides more of a “Store Front” approach offering various products and services providers, which captures customers' interests and makes the website look and feel like a one stop shopping destination. This approach is enhanced with the “neighborhood feel” where some or a majority of the displayed merchants and promotions are in close proximity to the customers.

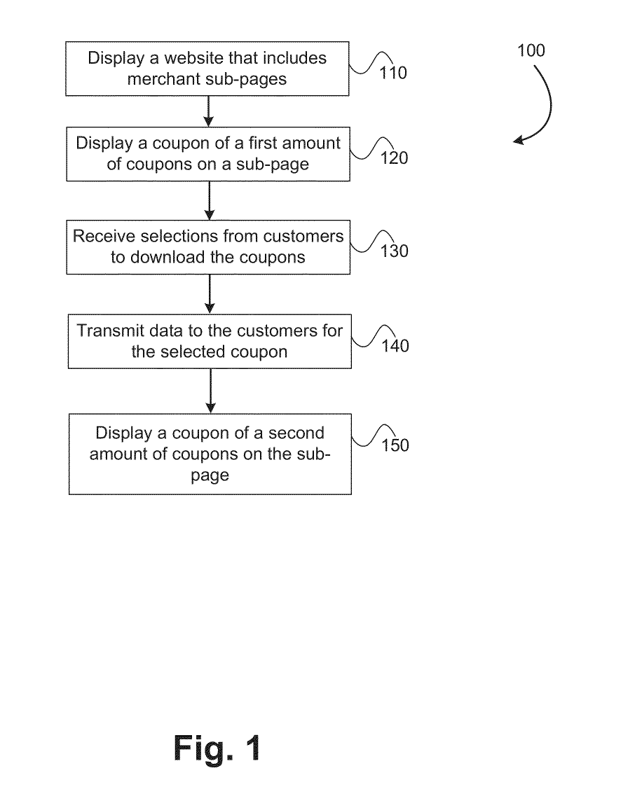

Referring now to FIG. 1, illustrated is a method for advertising coupons via a website. At block 110, a website is displayed that includes merchant sub-pages or webpages. The various webpages allow respective merchants to offer discounts and/or promotional materials for goods or services offered in one or more stores of the merchant. At block 120, a coupon is displayed on a sub-page of one of the merchants. The coupon is associated with a discount or promotional material offered by the merchant and may have traceable indicia so that the merchant can track information on the redemption of the coupon as described herein. Further, the coupon is one of a plurality of coupons, or a first amount of coupons, to be offered on the sub-page. The coupon may be displayed on the sub-page until a download count of the coupon reaches the first amount. For example, the website may be contractually obligated to offer 500 coupons for a discounted pizza for a pizza business. The coupon may be displayed on the pizza business's sub-page or webpage until the coupon has been downloaded 500 times by various customers. In another embodiment, the plurality of coupons or first amount of coupons represents an unlimited amount of coupon advertisements for a defined time, such as one month. In yet another embodiment, the plurality or first amount of coupons represent an unlimited amount of coupon advertisements for a defined period, where an initial amount of coupons are advertised (e.g., 500), and this number is adjusted, or the advertised product changed, based on the demand for the coupons. As described above, the merchant may pay a flat fee for the first amount of coupons to be displayed and advertised on the sub-page. The displaying step shown in block 120 may be performed in response to received payment from the merchant for the plurality of coupons and/or reception of a contractual agreement on the advertisement and terms of the coupons.

At block 130, selections are received from the various customers to download the coupons. In embodiments where only a limited number of coupons are offered (e.g., 500 coupons), the ability to select the coupon or the display and advertisement of the coupon may be removed with the download count reaches the limited amount. At block 140, data is transmitted to the customer to allow the customer to print the selected for subsequent redemption at the merchant's store. The data may be transmitted wirelessly or over a wired connection as known in the art. Further, the data may be transmitted to the customer's computer, wireless device, cell phone, and the like for download and subsequent printing. Printing the coupon may involve printing a hard copy on a piece of paper or other material, or may include displaying the coupon on a display device, such as a screen, or a computer, wireless device, cell phone, and the like. The customer may redeem the coupon may providing the physical or hard copy of the coupon to a sales representative at the merchant's store or by displaying the coupon to the sales representative.

At block 150, an additional coupon is displayed on the sub-page of the merchant. Block 150 is an optional step that need not be performed, especially in embodiments that limit the number of coupons that may be advertised and downloaded. Or, in some embodiments, block 150 may represent a second advertisement that is displayed for a second good or service offered by the merchant. In a specific embodiment, block 150 is performed when the merchant has contracted for an unlimited or large number of advertisements, but has limited an initial offering to a lesser number. For example, the merchant may have purchased unlimited advertising for one month via the website, but limited the initial offering of a good or service to 500 coupons in order to test demand and/or limit the merchant's liability for the good or service. If the 500 coupon limit is reached within the one month time limit, the merchant may desire to adjust the limit or advertise another good or service, and thus, may request or instruct that a second amount of coupons be advertised and displayed on the sub-page for subsequent download and redemption. As briefly mentioned, the second amount of coupons may be associated with the original discount or promotional material offered by the merchant or may be related to another discount or promotional material. This adjustment process can continue as long as the coupon limit is reach within the defined time limit, or until a contractual coupon advertising obligation is fulfilled. Further, since the merchant has paid a flat fee for unlimited or a large volume of advertising, the merchant may not be obligated to pay an additional fee if the coupon limit is adjusted or the advertised good or services is subsequently changed.

This arrangement provides an incentive for merchants since a large number of goods or services can be advertised and/or coupons can be tailored and adjusted without incurring additional costs. This arrangement also provides a great deal of advertising flexibility for merchants when compared to similar arrangements offered by conventional website advertisers. This arrangement also prevents the merchant from being obligated to service an unexpected volume of customers, which might occur if unlimited advertisement and download of the coupon was offered without any restrictions. For example, the merchant may be expected to service the customers if the coupon is unexpectedly popular and provisions are not in place to limit the coupon downloads. The merchant may have insufficient resources to service the customer, which may anger or otherwise discourage the customer and affect future relationships.

In one embodiment, the website may be configured to handle unexpectedly popular orders even when a provision is not established by the merchant to do so. For example, the website may be able to buffer the orders to allow the merchant to authorize download of the coupons. For example, when the customer selections in block 130 exceed the first amount of coupons of block 120, the webpage may notify the customers (e.g., via text, email, a webpage message) that the coupon limit has been exceeded but allow them to request download of the coupon anyway. The webpage may then notify the merchant that the customer selections were greater than the limited number of coupons and inquire about whether the merchant wants to authorize download of the coupons beyond the defined limit. The merchant may review the coupon demand and the available resources and either authorize the additional downloads or deny the additional downloads. The webpage may subsequently notify the customers of the merchant's decision and allow the coupons to be downloaded or deny the download. In some embodiments, the customers may not request the download, but the webpage may acknowledge that the customer attempted to click on the already exhausted coupon. The webpage may track the customer identification and notify the merchant that an additional customer, or customers, has attempted to download the coupon beyond the defined limit and inquire about whether the merchant wants to authorize the additional download(s) of the coupon. If the merchant authorizes the download(s), the webpage may contact the customer, or customers, using the tracked customer identification(s) and inform them that the coupon is available for download.

In one embodiment, the website may limit the customers' ability to download the coupon even when the merchant has not established download limits. For example, the website may recognize that the coupon is unexpectedly popular by comparing download requests for the coupon to historical or statistical averages. If the download requests for the coupon are deemed abnormally high, the website may limit the customers' ability to download the coupon until the merchant has provided authorization to allow such downloads. In this manner, the merchant may be protected from servicing an unexpectedly high volume of customers. This automatic download volume feature may be a feature that the merchant can turn on or off depending on their desire and/or other conditions.

### Embodiment 2

According to a second embodiment, enrolled merchants can advertise coupons without paying a fee for such services. In this embodiment, instead of receiving a fee from the merchants, the coupon promotion services may be paid for by the customers or other entities. For example, the customers may pay a fee for a defined number of coupon downloads, such as 100 downloads. In another embodiment the customer pays as he or she goes, meaning the customer only pays when a coupon is selected and requested for download. The customer may be redirected to a payment service or payment screen where they can pay a fee before being allowed to download the coupon. In another embodiment, the coupon is provided to the customer after the customer performs a desired service, such as filling out an online form. For example, the customer may be provided with a survey or questionnaire. Access to the coupon downloaded may be granted when the survey or questionnaire is submitted or uploaded to the website. An entity desiring the information on the form may pay a fee for each questionnaire received, which can be used to cover the coupon promotion services. The fees received from the customer and/or other entity may be divided between an entity providing the coupon promotion services and the respective merchants based on the requests for the respective merchant's coupons. This fee sharing arrangement may incentivize the merchants to offer coupons for download via the website.

Other aspects of the website may include allowing the merchant an initial amount of time (e.g., 30 days) within which to offer and sell coupons. This initial time period allows the merchant essentially free on-line marketing of their products and/or services. According to one embodiment, if the coupons are sold within the initial time frame, the website promoter (i.e., the entity offering coupon promotion services) may ask the merchant to increase the number of coupons available for advertising and download. Alternatively, the website promoter may request that the merchant offer a new coupon associated with a different discount or promotional material for advertisement and download. Both the merchant and website promoter share a common goal of downloading coupons since revenue is generated for both entities.

As described above, to provide a further advertising incentive for the merchant, the website may offer the merchant exclusive advertising rights or one of a limited number of advertising slots within a geographic area and/or for a defined amount of time. The website may also offer the above described “neighborhood feel” incentive, which may help new business establish a foothold within a geographic area, or help established businesses grow their footprint within the geographic area.

To enhance the “neighborhood like” feel and/or promotional opportunities for the merchants, each customer may be required to input one or more pieces of information when enrolling in the coupon promotion service. For example, the customers may be asked to input their email, zip code, and/or wireless device number upon entering the site. This information may be used by the website to advertise or market the various coupons as described herein. Further, the website may also be configured to determine the geographic location of the customer using known techniques, such as by determining the geographic location of the customer's wireless device. The website may compare the determined geographic location of the customer to the entered zip code to determine if the customer is within their “neighborhood” or outside of their zip code area. Coupon advertising and marketing may be sent to the customer according to this determination.

The website may have online tools to allow the customer to purchase and/or redeem coupons. For example, an online payment service (e.g., PayPal®) may be used to allow the customers to pay for coupon downloads and/or allow merchants to pay for the advertising services described herein. The online payment service may also be used by the website promoter to allow the promoter to pay the merchant when payment for downloaded coupons has been received from the customer or other entity. Payment may be made at defined periods, such as once or twice a month, or may be made in real time as they are received. One advantage of this arrangement is that the merchant receives payment for the coupon regardless of whether the customer redeems the coupon or not.

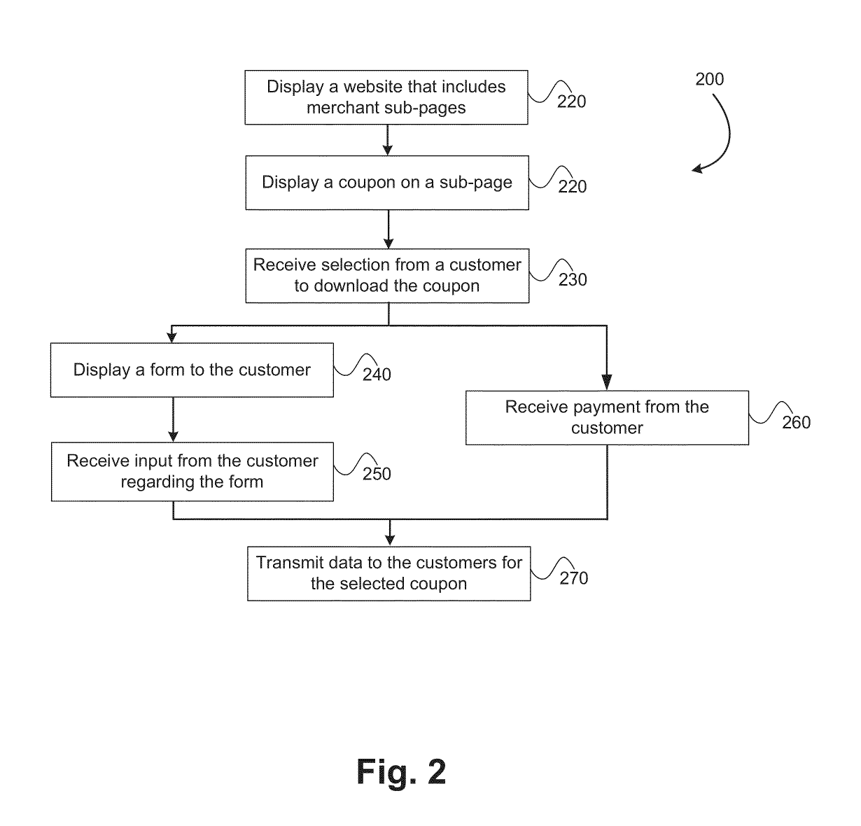

Referring now to FIG. 2, illustrated is a method for advertising coupons via a website. At block 210, a website is displayed that includes merchant sub-pages or webpages. The various webpages allow respective merchants to offer discounts and/or promotional materials for goods or services offered in one or more stores of the merchant. At block 220, a coupon is displayed on a sub-page of one of the merchants. The coupon is associated with a discount or promotional material offered by the merchant and may have traceable indicia so that the merchant can track information on the redemption of the coupon as described herein. At block 230, a selection is received from a customer to download the coupon. In one embodiment, receiving the selection from the customer to download the coupon includes receiving a selection of a link transmitted to the customer to advertise the coupon. For example, the website may transmit an advertisement of the coupon (via email, text messaging, and the like) to the customer. The advertisement of the coupon may include a link to the merchant's sub-page or webpage that displays the coupon or to another site where the coupon can be potentially downloaded. The customer may select the link and be transferred to the merchant's sub-page or another site.

At block 240, a form is displayed to the customer in response to receiving the selection from the customer to download the coupon. The form may have a plurality of data fields configured for customer input, such as a questionnaire or a survey. The data fields may include drop down boxes, alphanumeric fields, date or time fields, yes/no fields, and the like, that allow the customers to enter vast information. The data fields may follow specific target questions that are designed to elicit certain information from the customer, such as the customer's interest, spending habits, education, race, sex, origin, vacation destination, hobbies, marital status, income, and/or any other information that may be desired. The forms may be designed by or for a specific entity desiring the information, such as a corporation, government, hospital, school, organization, and the like. The information obtained may be used for advertising, marketing, education, product design, or for any other reason.

According to one embodiment, the customer is automatically routed to a site having the form in response to clicking on a button displaying or advertising download of the coupon on the merchant's sub-page or webpage. According to another embodiment, the customer is routed to the site upon selection of the link transmitted to the customer in the coupon advertisement. In any manner, the customer may be required to complete the form, survey, questionnaire, and the like, in order to be able to download the coupon. At block 250, input is received from the customer for one or more of the data fields. The customer's input may be recorded as it is input into the data fields displayed on the webpage, or may be received via email, text message, and the like. In one embodiment, the form may be completed and the customer provided with a code that is input into the webpage or a link to another site offering the coupon download. The code may be provided in response to the customer completing the form online, via interactive voice response (IVR), submitting the form via email, text message, or in another manner. After the input is received from the customer, the customer may be allowed to download the coupon or the download process may begin automatically. It should be realized that block 240 and 250 are optional processes that occur when a form, such as a survey, is provided to the customer as a condition for downloading the coupon and that these steps need not occur.

At block 260, payment may be received from the customer to pay for download of the coupon. As described above, the payment may be made in real time with the selection and/or download of the coupon, or may be received prior to the customer accessing selecting the coupon for download. For example, in one embodiment, the customer may purchase coupon downloads in bulk, such as purchasing 100 downloads for a set fee. The website may limit the customer's downloads to the purchased amount based on a fee collected from the customer. The website may deduct a download each time a coupon is selected and/or downloaded until the customer exhausts his or her available coupon credits, after which the customer may be blocked from downloading coupons. In another embodiment, the customer may have a prepaid account that may be debited each time the customer selects and/or downloads a coupon. In any manner, the customer may pay for selected coupons prior to downloading them. It should be realized that block 260 is an optional process that need not occur. The coupons are typically purchased for less value than the customer is saving, which provides an incentive for the customer to purchase the coupons. For example, the customer may send $2.00 on a coupon, but receive a 50% savings worth approximately $15.00. As such, the customer will save $13.00 even though the customer paid for the coupon.

At block 270, data is transmitted to the customer for the selected coupon. The coupon may subsequently be printed by the customer, or displayed on a display device, for redemption at the merchant's store.

In one embodiment, the website may require that a merchant discount a product of service by a defined amount in order to advertise the coupon on the website. For example, the website may require a discount of 40% or more for advertisement of the coupon on the website. Thus, the website may limit display of coupons to those coupons having a defined discount off the regular retail price of the promoted good or service.

In any of the embodiments described herein, fraud detection techniques known in the art may be employed to ensure that a single customer is not repeatedly downloading coupons from a merchant. For example, a computer or laptop's Internet Protocol address (IP address) may be recognized and recorded by the website. The computer of laptop associated with the IP address may be limited to downloading a defined number of coupons from each merchant per day, week, month, and the like. The download and time period restrictions may be set and modified by the individual merchants.

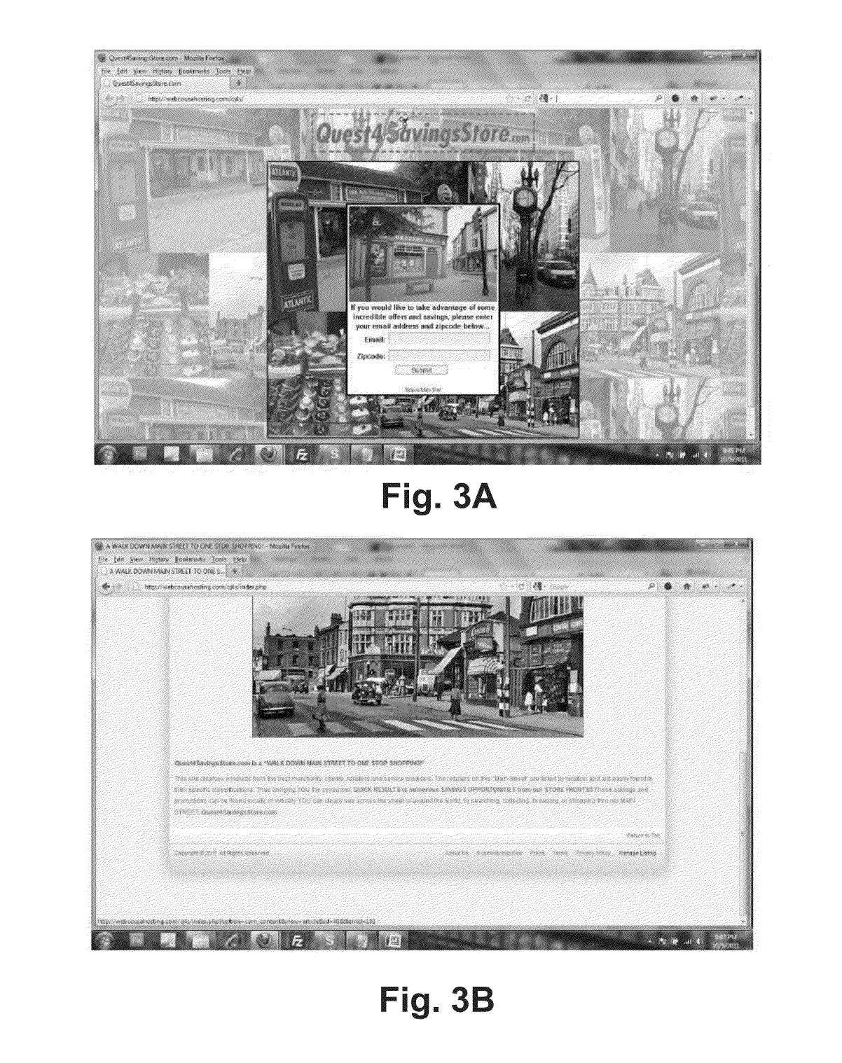

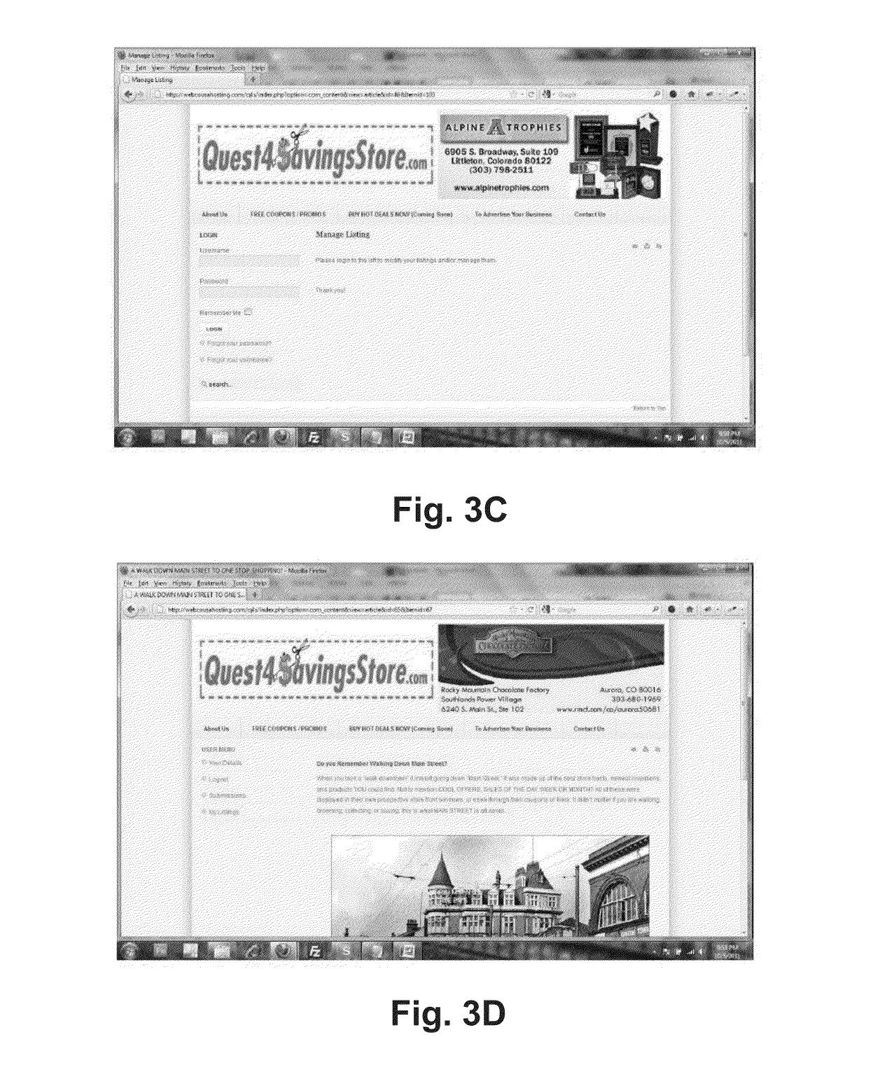

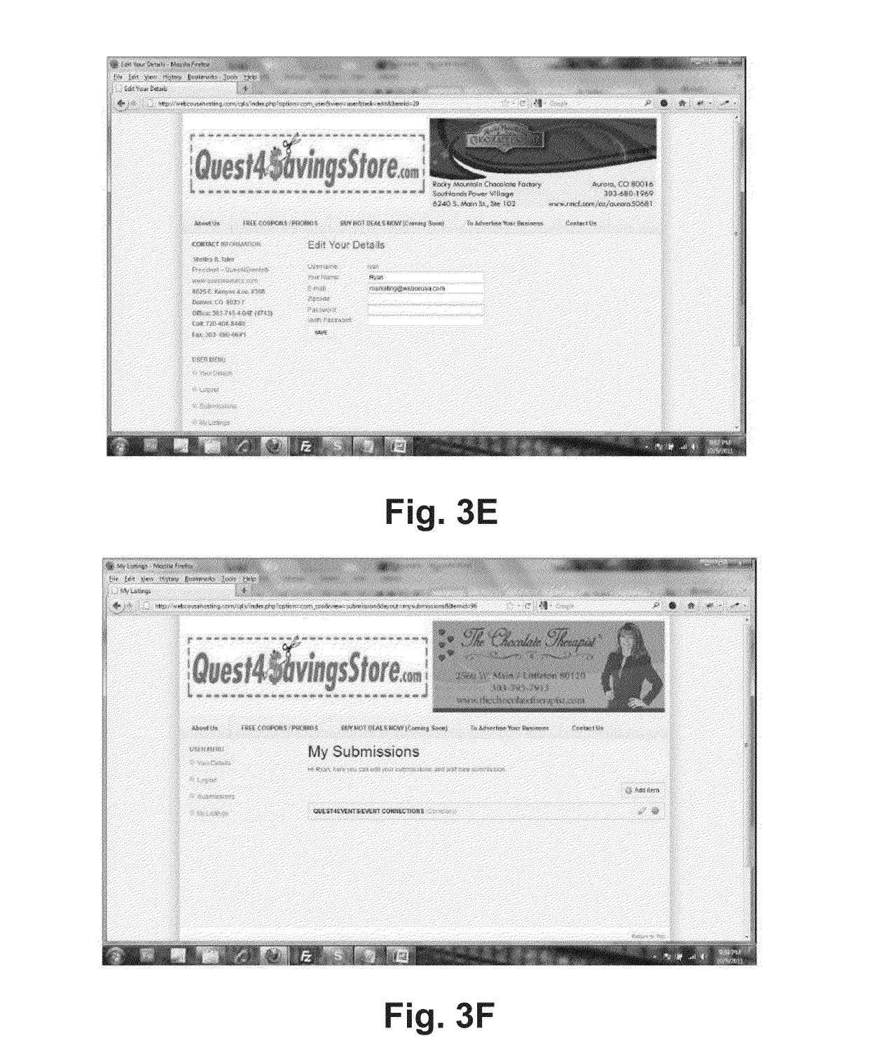

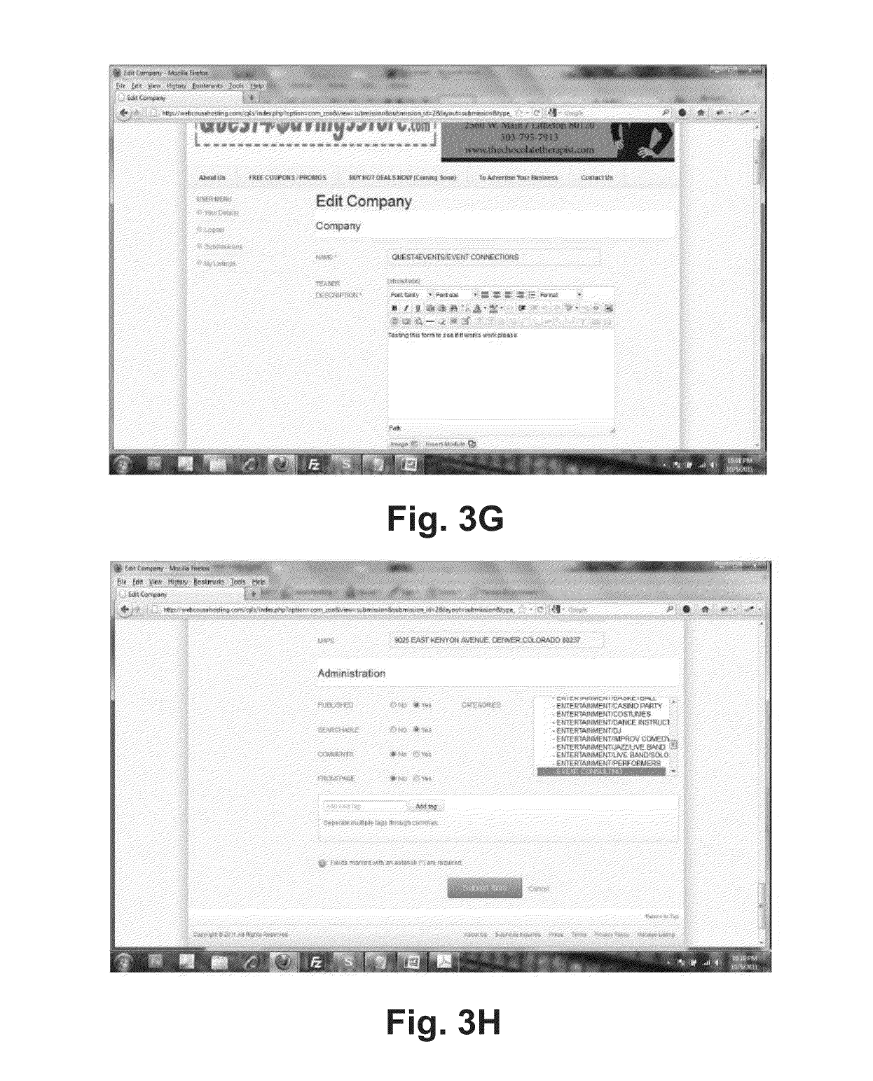

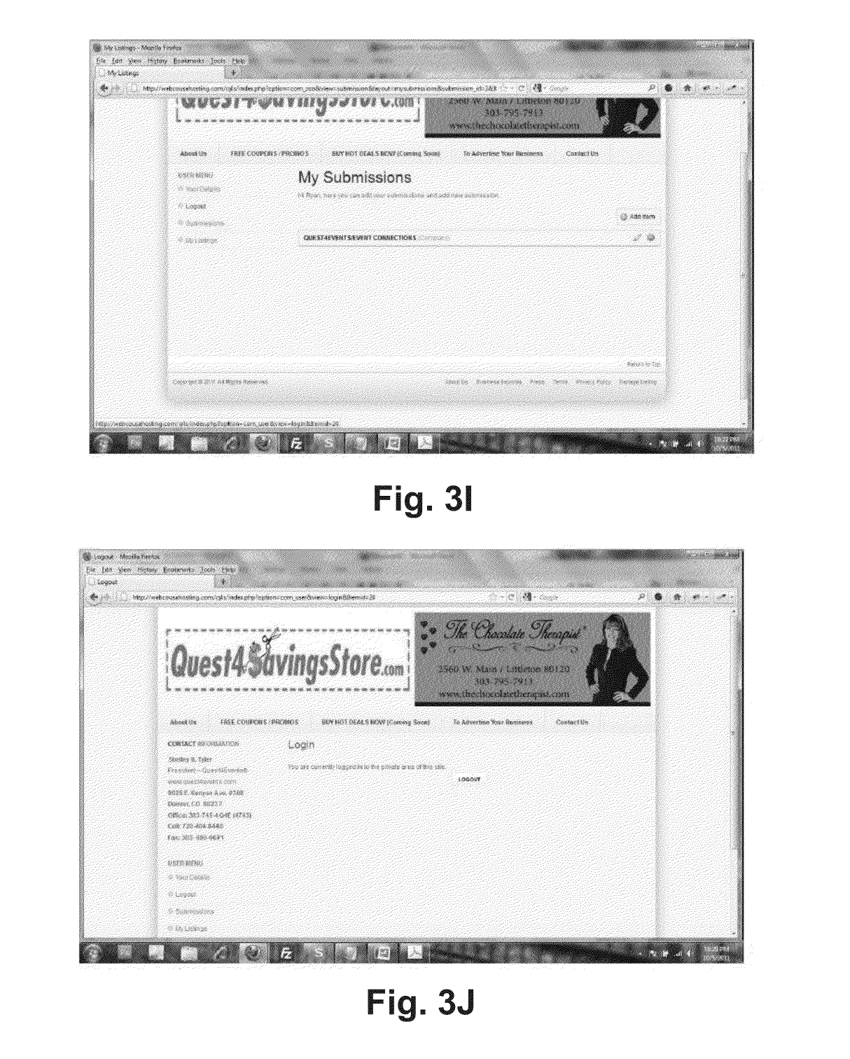

Referring now to FIGS. 3A-J, illustrated are various screen shots of a website of a coupon promotion program that merchants and customers may enroll in. Specifically, the screen shots illustrate various webpages that allow a merchant to list advertisement, change advertisements, advertise goods or services offered, design a webpage layout, and the like. FIG. 3A illustrates a main page of the website of a coupon promotion program. The user may be requested for an email address and/or zip code. Upon entering the email address, the website may recognize the user as a merchant or customer and redirect the user accordingly. FIG. 3B illustrates a homepage of the website that allows the merchant to manage listings or advertisements and that also offers other information associated with the website (e.g., terms, privacy policy, and the like). Upon selection of the “Manage Listing” link or tab, the merchant may be directed to a login page as shown in FIG. 3C. The Merchant is authenticated by entering a username and password, which may be selected by the merchant and/or provided by the website. Once the merchant is authenticated, the merchant is routed to the screen that allows the merchant to manage listing, submit new advertisements or listings, change a password, change user information, and the like. Specifically, the screen may contain a user menu having a selectable link or tab for each of these options.

FIG. 3E illustrates a screen shot where the merchant may edit their personal information and/or information for their business. For example, the merchant may enter a new email address for the business and/or a new street address and zip code in case the business has recently relocated. The merchant may also update or change their password. The current information for the merchant may be displayed on the left hand side of the screen.

FIG. 3F illustrates a screen shot where the merchant's submissions are displayed. This screen may be accessed by selecting a “My Listings” link or tab displayed on the website. The submissions are the current coupons, discounts, or advertisements that are being displayed on the merchant's sub-page or webpage. The submissions may be accessed and edited from this screen by selecting an editing icon displayed proximate the submission, such as a pencil. The screen may also display a delete icon, such as a red X, proximate the submission. Clicking the editing icon displays an editing screen, as shown in FIG. 3G. The editing screen allows the submission to be modified or edited. The editing screen may allow the merchant to enter or submit one or more of the following pieces of information related to the submission: business name, categories for the submission, a primary category for the submission, a brief or teaser description of the submission, a plurality of images for display, a business address, a telephone number, a fax number, an e-mail address, a business website, a company logo, a coupon price, a value of the coupon (e.g., 25% off, $10 off, buy one get one free, and the like), a discount amount (how much the customer is saving), an ID and expiration date for the coupon, a library image, a map location to the business location, a short description of the business, and the like.

Once the submission has been appropriately edited, the merchant may select a “Submit Item” button, which directs the merchant to the screen shown in FIG. 3H. This screen allows the merchant to choose categories to list the submission under. For example, the merchant may choose entertainment, automobile repair, education, and the like, depending on the submission previously entered. The merchant may select multiple categories when the submission falls under one or more such categories. The screen also allows the merchant to select whether or not to display the coupon or advertisement associated with the submission or not. For example, the merchant may select a “No” or “Yes” button displayed proximate to a “Published” tab to either display or not display the submission. Likewise, the merchant may render the submission searchable by selection “No” or “Yes” button displayed proximate to a “Searchable” tab. Upon completion of the submission, the merchant may select a “Submit Item” button to finalize and display the coupon and/or advertisement or may select a “Cancel” button to cancel the submission. The merchant may likewise re-edit the submission is needed.

After selecting the appropriate button, the merchant may be rerouted to the My Submissions screen shown in FIG. 31 where the merchant will be able to re-edit the submission, edit other submission, submit new submissions, and the like. The merchant may also logout by selecting a logout button or link, whereupon the merchant is directed to a logout screen as shown in FIG. 3J and the coupons and/or advertisements are displayed on the merchant's sub-page or webpage.

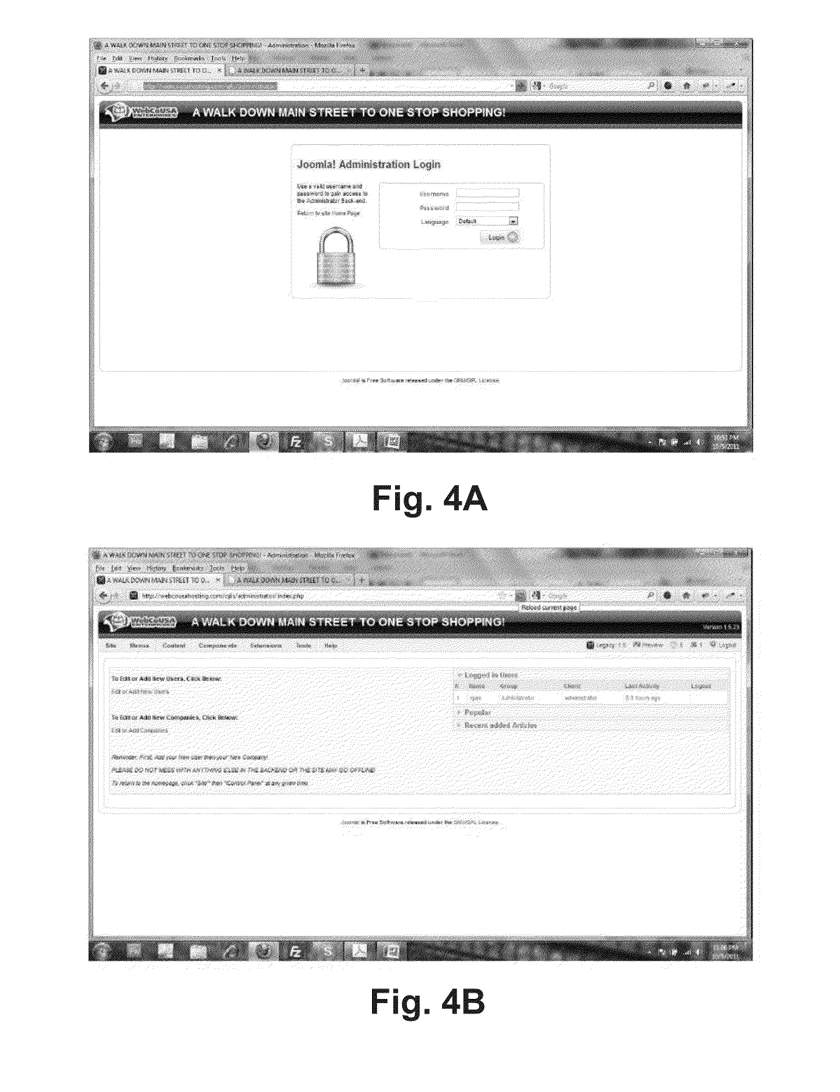

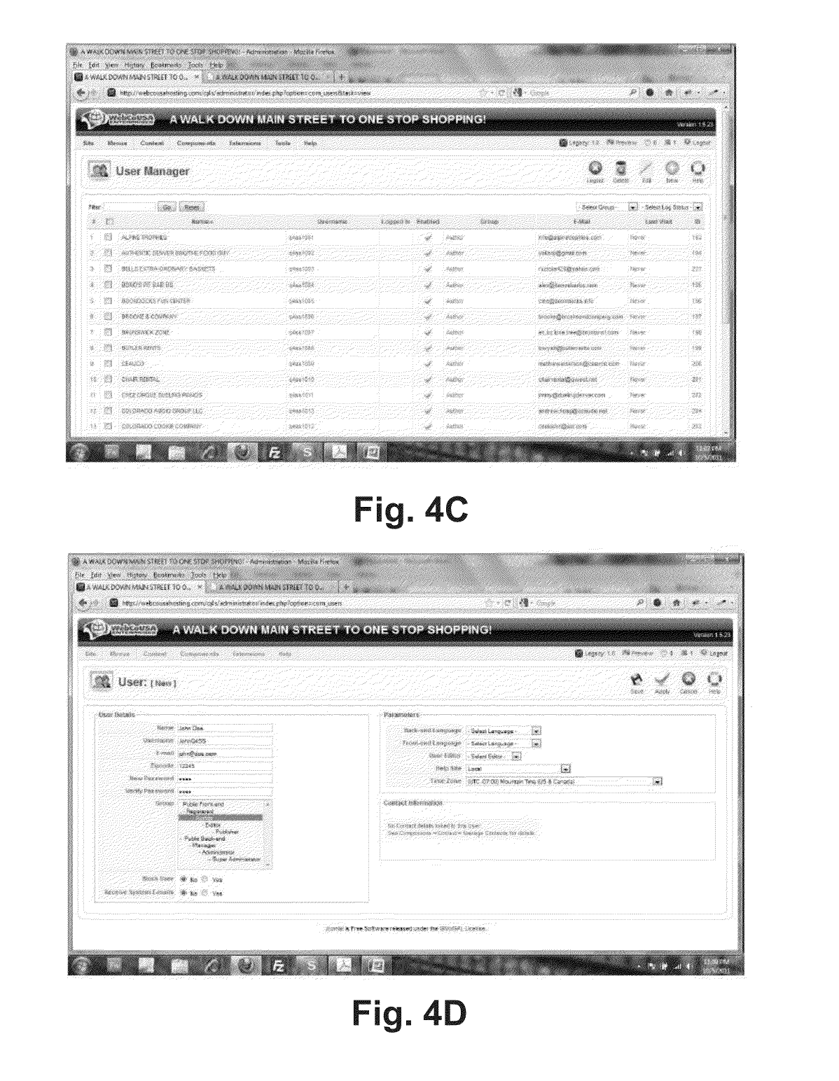

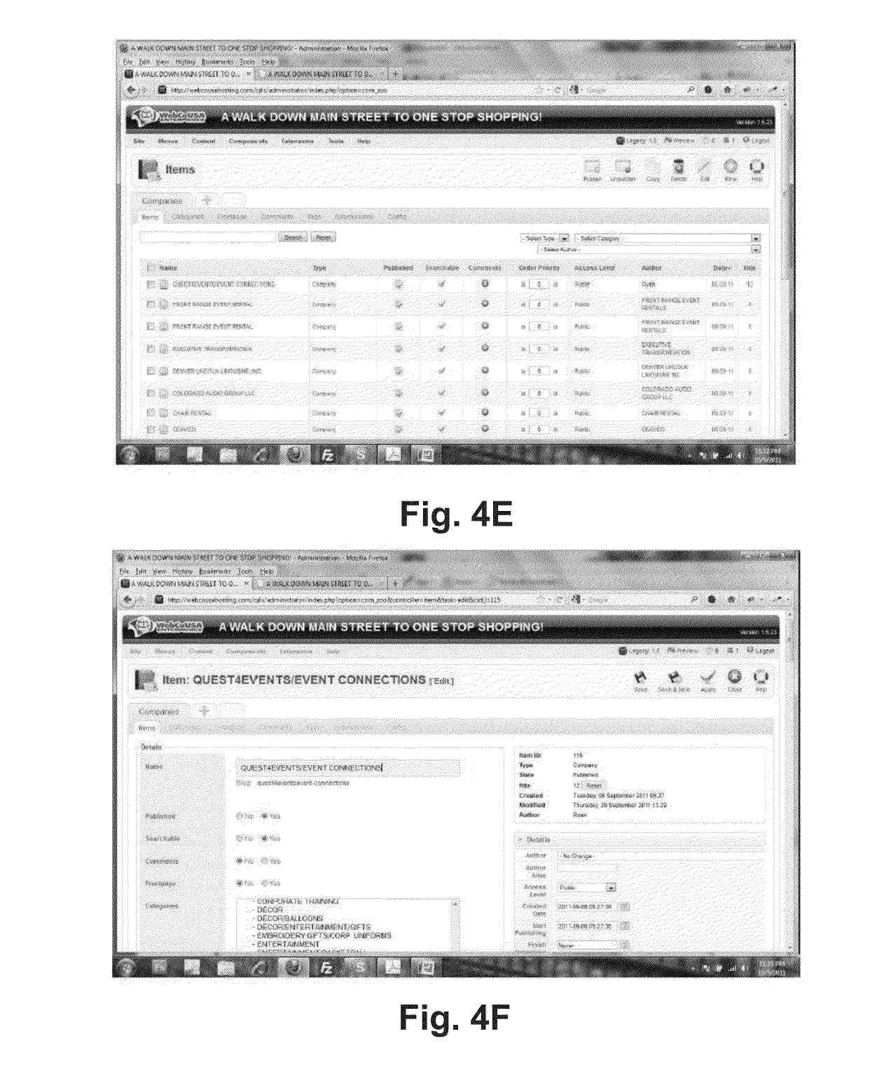

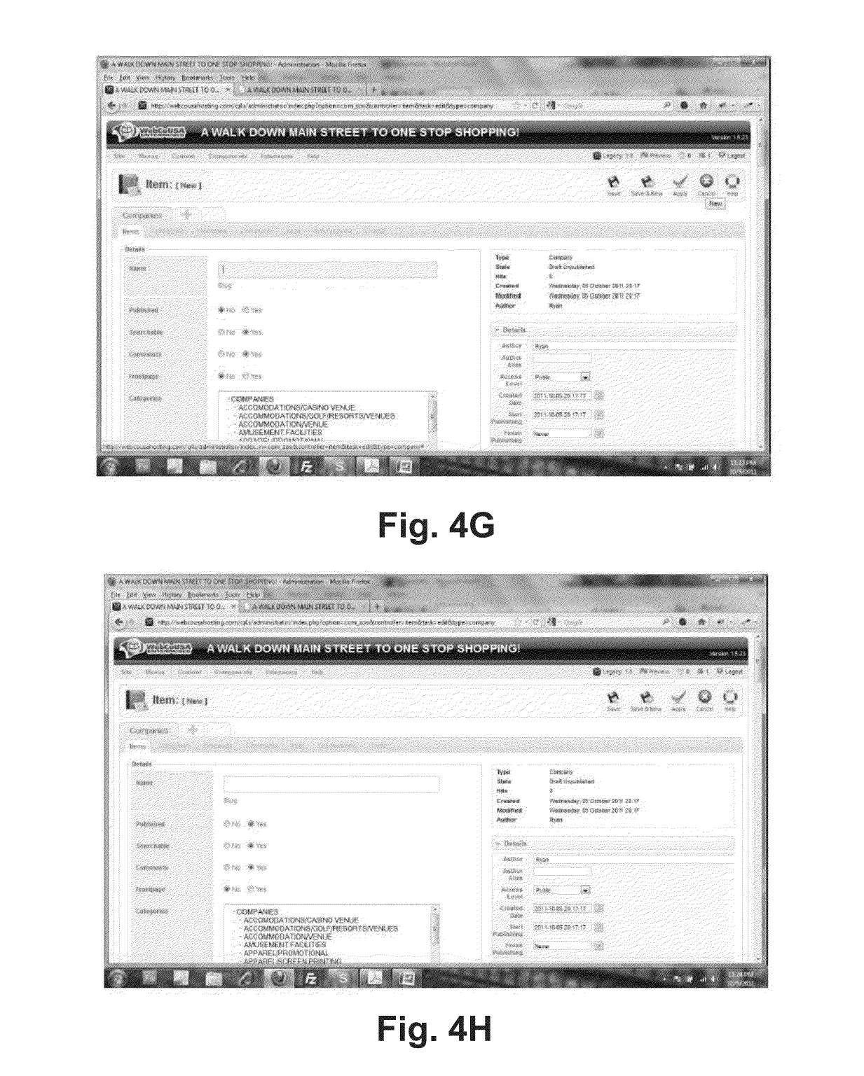

Referring now to FIGS. 4A-H illustrated are various screen shots of a website that allows an administrator of the coupon promotion program to monitor and control the content displayed on the merchant's sub-pages or webpages, control the content displayed on the main coupon promotion website, control or monitor customer usage and activities, and the like. FIG. 4A shows an administrations login screen where an administrator can enter their username and password for authentication purposes.

Once the administrator is authenticated, the administrator may be directed to a main homepage as shown in FIG. 4B. The administrator may select a desired function to perform, such as adding or editing new or existing customers, adding or editing new or existing companies, and the like. FIG. 4C illustrates a screen shot where the administrator is able to add or edit new or existing customers. The administrator may also filter the customers by selection of a group, username, and the like. Upon selection of a specific customer or selection to add a customer, the administrator may be routed to a customer edit screen as shown in FIG. 4D. In this screen, the administrator may block a customer, edit personal information of the customer (if necessary), change or reset a password or username, and the like. The administrator may also assign various user rights for the customer, such as whether the customer is assigned as an author, editor, or publisher on a merchant webpage. These rights allow the customer to edit or modify a webpage or submit new submissions, such as when the customer is associated with one of the merchant webpages.

FIG. 4E illustrates a screen shot where the administrator is able to add or edit new or existing merchants. This screen shows information about each merchant and allows the administrator to perform several actions. For example, the administrator may change the priority order for the merchant and/or change whether the merchant is searchable or published. Upon selection of a specific merchant or selection to add a merchant, the administrator is routed to a merchant edit screen as shown in FIG. 4F-H. If a new merchant is to be added, the administrator may select a add icon, such as a tab display a + sign or some other icon. The administrator may then be able to enter or submit one or more of the following pieces of information for the merchant to be added: business name, categories for submissions, a primary category for the submission, a brief or teaser description of the submission, a promotional description of the business and/or submission, a plurality of images for display, a business address, a telephone number, a fax number, an e-mail address, a business website, a company logo, a coupon price, a value of the coupon (e.g., 25% off, $10 off, buy one get one free, and the like), a discount amount (how much the customer is saving), an ID and expiration date for the coupon, a library image, a map location to the business location, a short description of the business, and the like. The administrator may then finalize the new merchant listing in a manner similar to that previously described.

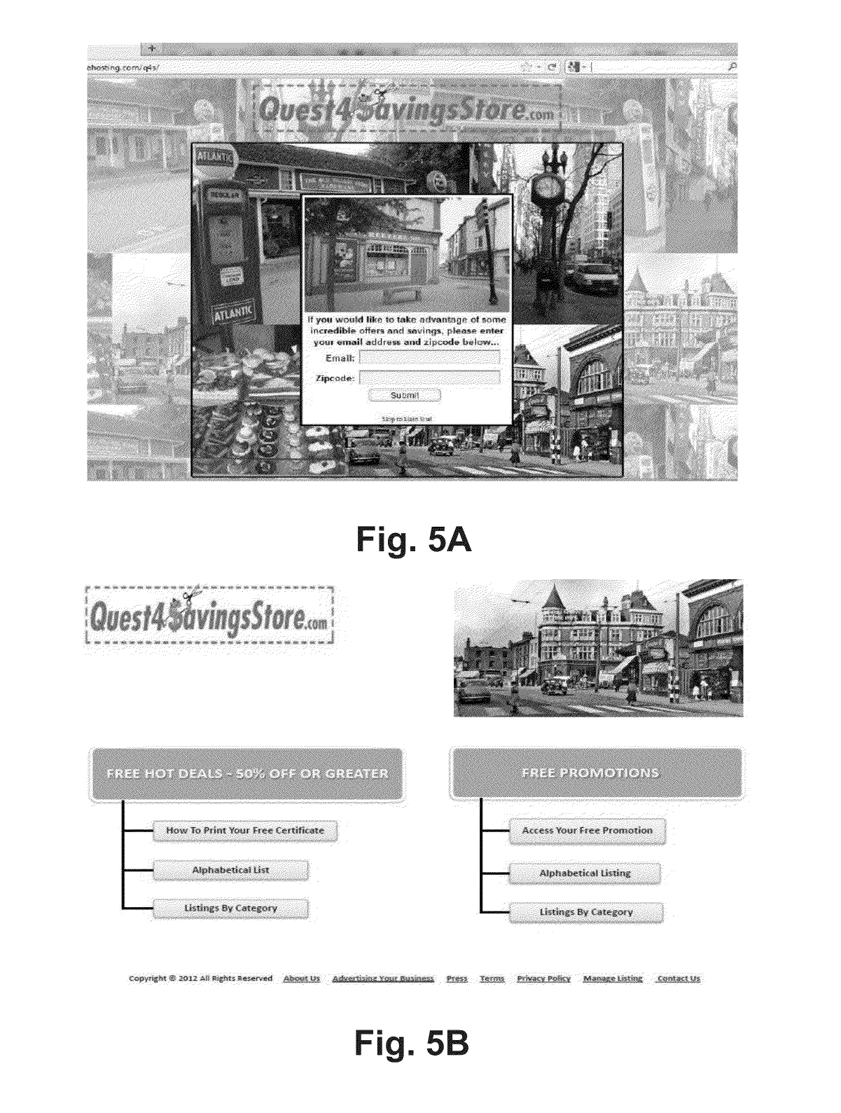

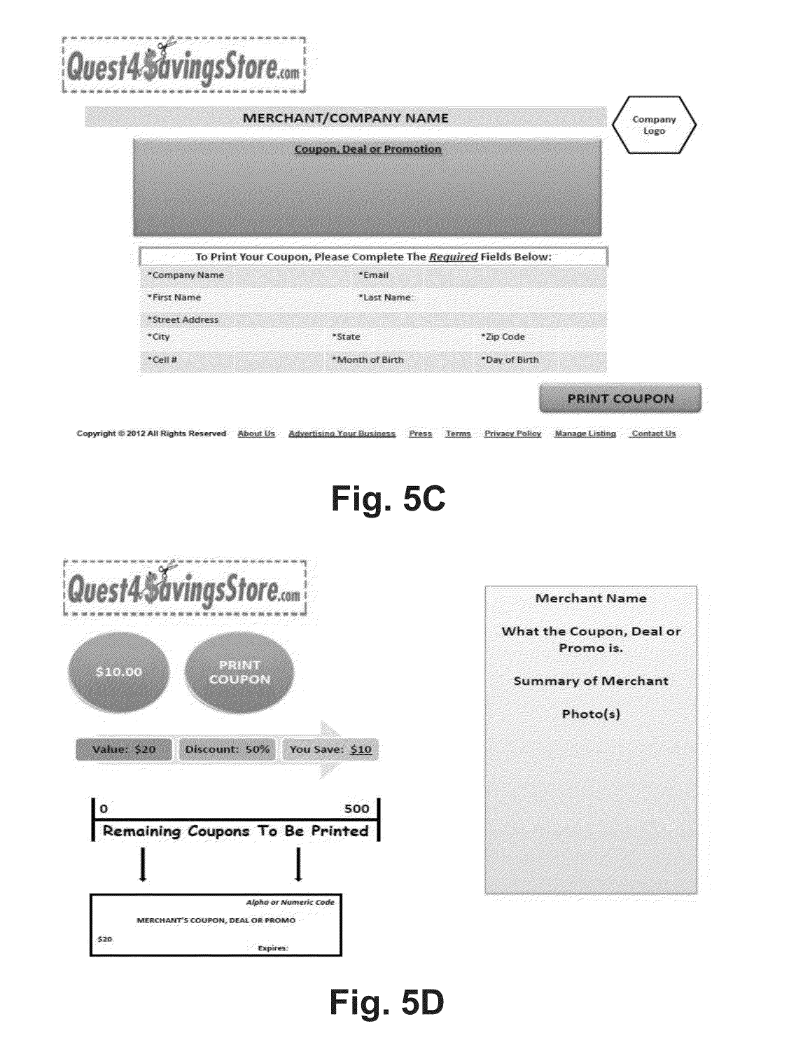

Referring now to FIGS. 5A-D, illustrated are various screen shots of the website of the coupon promotion program. Specifically, shown are some of the screens that may be displayed to a customer searching for coupons, discounts, or other promotional materials. FIG. 5A illustrates the home screen of the website as described previously. Upon entering a username and zip code, the website may recognize the user as a customer and route the customer to the screen shown in FIG. 5B. At this screen the customer may be presented with one of two coupon options: Free Hot Deals or Free Promotions. The coupons and features presented by these two options may correspond to the embodiments described above. For example, the Hot Deals option may correspond to coupon options where the customer is able to obtain coupons by completing a survey or other form, or by purchasing the coupons. The Free Promotions option may correspond to coupon advertisement that the merchant has purchased in bulk as described above.

Each option may allow the customer to select a function to perform, such as accessing a promotion of printing a coupon, browsing alphabetical listings of the merchants, browse listings by category, and the like. FIG. 5C illustrates a screen where the customer may be required to enter information about themselves and/or their company. The information may include a company name, a first and last name of the customer, an email address, a street address of a home or business, a zip code of the home or business, a city and state of the home or business, a cell phone number, a month and date of birth, and the like. Entering some or all of this information may be optional. Alternatively, the screen shown in FIG. 5C may represent a form or survey that is presented to the customer for completion in order to obtain a coupon download. The form or survey will often have additional information that is specifically designed to elicit certain information. FIG. 5C may also display one or more coupons and/or a company logo.

FIG. 5D illustrates a representation of a merchant sub-page or webpage that may be presented to a customer. The webpage may display the merchant's name, the coupon, deal, discount, or promotions being offered. A summary of the merchant and/or any uploaded photos of the merchant or good or service being offered. The webpage may also display the coupon and information related to the coupon such as a discount offered (e.g., 50%), the value of the good or service offered (e.g., $20), and the amount the customer saves (e.g., $10). The webpage may also display the format of the coupon including the indicia (e.g., alphanumeric code, and the like) that identifies the coupon and allows the merchant to track redemption, an expiration date of the coupon, the value, and the like. The webpage may include a selectable button that allows the coupon to be printed and/or routes the customer to other sites as described herein. The webpage may further display a number of coupons remaining that may be downloaded and printed and/or display a number of downloads remaining for the customer.

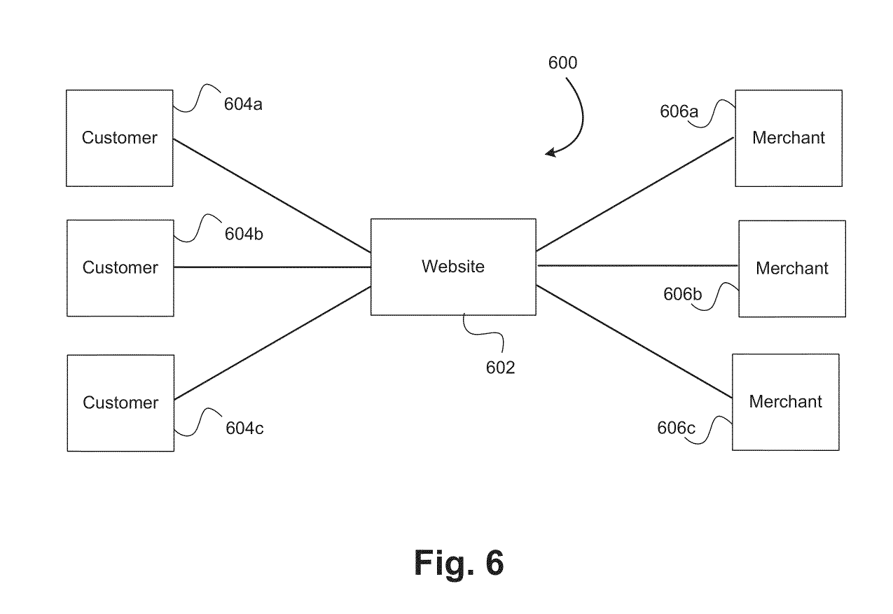

Referring now to FIG. 6, illustrated is a system 600 for advertising coupons, discounts, or other promotional materials. The system includes a website 602 as described herein, that communicatively links various customers 604a-c and merchants 606a-c to allow the merchants to display and the customers to view various coupons, advertisements, promotions, and the like as described herein. Although not shown, the system 600 may include various computers, databases, memory devices, computer readable mediums, interfaces, servers, processors, and the like as known in the art to allow the various functions and operations described herein to be executed. For example, these servers, processors, computer readable mediums, and the like, may store various instructions, information related to the customers and merchants, information about the offered coupons, and the like. The processor(s) may execute instructions stored on the computer readable medium(s) that are located on servers, either remote or internal to system 600, to perform the methods, operations, and/or functions described herein. Customers 604a-c may interface with website 602 via various computer systems, wireless devices, cell phones, kiosks, and or through any other manner known in the art. The merchants may likewise interface with website 602.

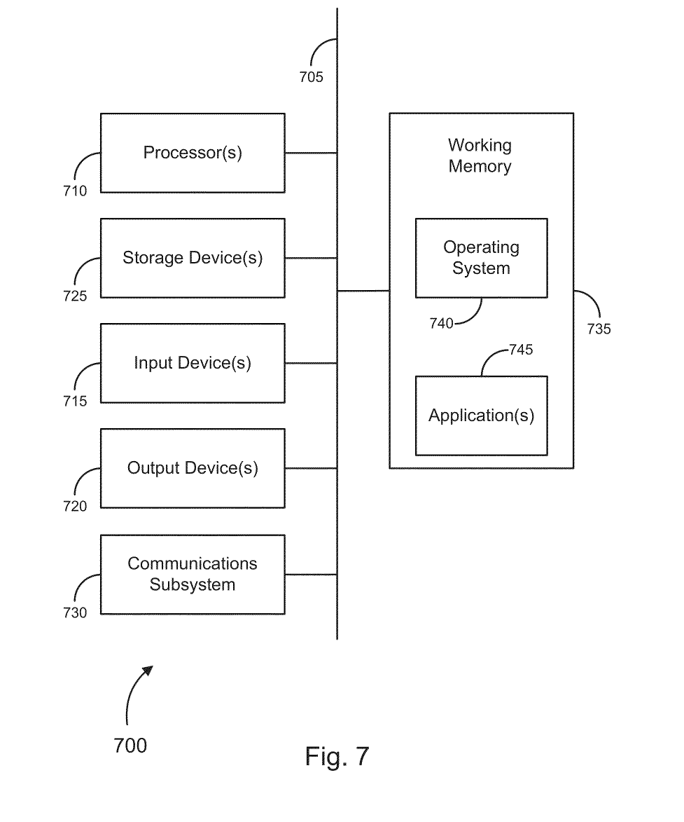

Referring now to FIG. 7, illustrated is a schematic of one embodiment of a computer system 700 that can perform the methods of the invention, as described herein, and/or can function as, for example, a server or computer system hosting the describe coupon promotion website. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements can include one or more processors 710, including, without limitation, one or more general-purpose processors and/or one or more special-purpose processors (such as digital signal processing chips, graphics acceleration chips, and/or the like); one or more input devices 715, which can include, without limitation, a mouse, a keyboard and/or the like; and one or more output devices 720, which can include, without limitation, a display device, a printer and/or the like.

The computer system 700 may further include (and/or be in communication with) one or more storage devices 725, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. Computer system 700 might also include a communications subsystem 730, which can include without limitation a modem, a network card (wireless or wired), an infra-red communication device, a wireless communication device and/or chipset (such as a Bluetooth® device, an 802.11 device, a Wi-Fi device, a WiMax device, cellular communication facilities, etc.), and/or the like. The communications subsystem 730 may permit data to be exchanged with a network (such as the network described below, to name one example), and/or any other devices described herein. In many embodiments, computer system 700 will further comprise a working memory 735, which can include a RAM or ROM device, as described above.

Computer system 700 can also comprise software elements, shown as being currently located within the working memory 735, including an operating system 740 and/or other code, such as one or more application programs 745, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 725 described above. In some cases, the storage medium might be incorporated within a computer system, such as the system 700. In other embodiments, the storage medium might be separate from a computer system (e.g., a removable medium, such as a compact disc, etc.), and or provided in an installation package, such that the storage medium can be used to program a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection with other computing devices such as network input/output devices may be employed.

In one aspect, the invention employs a computer system (such as the computer system 700) to perform methods of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another machine-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 700, various machine-readable media might be involved in providing instructions/code to processor(s) 710 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 725. Volatile media includes, without limitation, dynamic memory, such as the working memory 735. Transmission media includes coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc., carried by the signals) to the working memory 735, from which the processor(s) 705 retrieves and executes the instructions. The instructions received by the working memory 735 may optionally be stored on a storage device 725 either before or after execution by the processor(s) 710.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

As used herein and in the appended claims, the singular forms “a”, “an”, and “the” include plural referents unless the context clearly dictates otherwise. Thus, for example, reference to “a process” includes a plurality of such processes and reference to “the device” includes reference to one or more devices and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method for advertising coupons online comprising:
providing a database having information on a list of enrollees in a coupon program as well as merchant data identifying merchants and discounts and promotional materials on goods or services offered in stores of the merchants;
displaying a website comprising sub-pages, each sub-page being associated with one of the merchants to allow the merchant to offer the discounts and promotional materials;
receiving payment from a merchant to enable download of a first amount of coupons from a respective sub-page of the merchant for a defined amount of time;
receiving instructions from the merchant to associate the first amount of coupons with an identified discount or promotional material being offered by the merchant;
generating the first amount of coupons;
displaying a coupon of the first amount of coupons on the sub-page for download by customers within the defined amount of time;
receiving, within the defined amount of time, selections from customers to download one or more of the first amount coupons from the sub-page such that the total customer selections for download equal the first amount of coupons;
receiving instructions from the merchant to make a second amount of coupons available for download on the sub-page;
receiving instruction from the merchant to associate the second amount of coupons with the identified discount or promotional material;
generating the second amount of coupons; and
displaying a coupon of the second amount of coupons on the sub-page for download by customers within the defined amount of time.

2. A method for advertising coupons online comprising:
displaying a website comprising sub-pages, each sub-page being associated with a respective merchant to allow the merchant to offer discounts and promotional materials on goods or services offered in a store of the merchant;
displaying a coupon on a sub-page of one of the merchants, the coupon being associated with a discount or promotional material offered by the merchant and having traceable indicia so that when the coupon is redeemed at the merchant's store, the merchant can track information on the redemption;
receiving a selection from a customer to download the coupon; and
transmitting data to the customer to allow the coupon to be printed by the customer for redemption at the merchant's store.

3. The method of claim 2, wherein the coupon is one of a first amount of coupons associated with the discount or promotional material, the first amount of coupons being available for download on the sub-page by customers within a defined amount of time, and wherein the method further comprises:
receiving a plurality of selections from customers within the defined amount of time for download of the coupon such that the first amount of coupons is exhausted;
receiving instructions from the merchant to make a second amount of coupons available for download on the sub-page within the defined amount of time; and
displaying a coupon of the second amount of coupons on the sub-page for download by customers.

4. The method of claim 3, wherein the second amount of coupons are associated with a different discount or promotional material.

5. The method of claim 3, wherein the merchant pays a fee for display of the first amount of coupons on the sub-page for the defined amount of time, and wherein the fee covers display of the second amount of coupons for the first amount of time.

6. The method of claim 3, wherein the plurality of selections received is greater than the first amount of coupons, and wherein the method further comprises:
notifying the merchant that the plurality of selections was greater than the first amount of coupons; and
receiving authorization from the merchant to allow download of coupons beyond the first amount of coupons.

7. The method of claim 2, wherein the discounts or promotional materials are categorized, and wherein the website is configured to limit the discounts or promotional materials offered for each category within defined geographical boundaries.

8. The method of claim 7, wherein the website limits the discounts or promotional materials offered for each category to a single merchant within each defined geographical boundary.

9. The method of claim 2, wherein the website limits the customer's download of coupons to a defined amount based on a fee collected from the customer.

10. The method of claim 2, further comprising:
displaying a form to the customer in response to receiving the selection from the customer to download the coupon, the form having a plurality of data fields configured for customer input;
receiving input from the customer for one or more of the data fields; and
in response to receiving input from the customer, allowing the data to be transmitted to the customer.

11. The method of claim 10, wherein receiving a selection from the customer to download the coupon comprises receiving a selection of a link transmitted to the customer to advertise the coupon.

12. The method of claim 2, further comprising receiving payment from the customer for download of the coupon.

13. The method of claim 12, wherein the website limits display of coupons to coupons having a defined discount off the regular retail price of the promoted good or service.

14. A computer system comprising:
a processor; and
a computer readable medium having instructions stored thereon, which when executed by the processor, cause the computer system to:
display a website comprising sub-pages, each sub-page being associated with a respective merchant to allow the merchant to offer discounts and promotional materials on goods or services offered in a store of the merchant;
display a sub-page when a respective merchant or sub-page is selected by a customer;
display a coupon on the sub-page, the coupon being associated with a discount or promotional material of the merchant and having traceable indicia so that when the coupon is redeemed at the merchant's store, the merchant can track information on the redemption;
receive a selection from the customer to download the coupon; and
transmit data to the customer to allow the coupon to be printed by the customer for redemption at the merchant's store.

15. The computer system of claim 14, wherein the instructions further cause the computer system to:
receive payment from the merchant for display of a first amount of coupons on the sub-page for download by customer within a defined amount of time, the coupon being one of the first amount of coupons;
receive selections from customers within the defined amount of time for download of the first amount of coupons such that the first amount of coupons is exhausted; and
receive instructions from the merchant to display a second amount of coupons on the sub-page, the second amount of coupons being displayed on the sub-page for download within the defined amount of time.

16. The computer system of claim 15, wherein the second amount of coupons are associated with a different discount or promotional material.

17. The computer system of claim 15, wherein the merchant pays a fee for display of the first amount of coupons on the sub-page for the defined amount of time, and wherein the fee also covers display of the second amount of coupons for the defined amount of time.

18. The computer system of claim 15, wherein the discounts or promotional materials are categorized, and wherein the website is configured to limit the discounts or promotional materials offered for each category within defined geographical boundaries.

19. The computer system of claim 14, wherein the instructions further cause the computer system to:
display a form to the customer in response to receiving the selection from the customer to download the coupon, the form having a plurality of data fields configured for customer input;
receive input from the customer for one or more of the data fields; and
allow the data to be transmitted to the customer in response to receiving input from the customer.

20. The computer system of claim 19, wherein receiving the selection from the customer to download the coupon comprises receiving a selection of a link transmitted to the customer to advertise the coupon.
